(19) United States
(12) Patent Application Publication
(10) Pub. No.: US 2012/0199536 A1
(43) Pub. Date: Aug. 9, 2012

(54) WATER FILTRATION SYSTEM

(76) Inventors: Alan Howard Dennis, Barrie (CA); Robert Lloyd Dennis, Barrie (CA); Robert Martin Garner, Angus (CA)

(21) Appl. No.: 13/168,787

(22) Filed: Jun. 24, 2011

(30) Foreign Application Priority Data
Feb. 9, 2011 (CA) 2731329

(51) Int. Cl. C02F 1/42; B01J 49/00; B01D 15/04

(52) U.S. Cl. 210/673; 210/138; 210/275

(57) ABSTRACT

A water filtration system having a tank, a fluid flow interface into the interior of the tank, and a control valve. The control valve is in fluid communication with the fluid flow interface. The control valve includes a source water inlet for receiving a flow of source water, a drain outlet, a treated water outlet and an air inlet, the control valve being operable to control a passage of fluids between the inlets and the outlets and the fluid flow interface. A filtration media is contained within the tank which includes a media mixture of manganese dioxide coated silica core filtration media and iron hydroxide filtration media. The control valve may be programmed to perform a filtering service process, a backwashing process and an air downflow process.

### CROSS-REFERENCE TO RELATED APPLICATIONS

This application claims the benefit of priority of Canadian Application No. 2,731,329 filed Feb. 9, 2011, the contents of which are herein incorporated by reference.

### TECHNICAL FIELD

Example embodiments relate generally to water filtration systems.

### BACKGROUND

Water can contain contaminants such as iron, sulfur and manganese. Some example water treatment systems include chlorination systems, ion exchange systems, and oxidation/filtration systems.

Filtration systems may contain a filtration material which is used to treat water to remove such contaminants. However, the contaminants may build up within the filtration material, which could adversely affect the efficiency of the filtering material.

Additional difficulties with existing systems may be appreciated in view of the description below.

### SUMMARY

In accordance with an example embodiment, there is provided a water filtration system, including a tank defining an interior; a fluid flow interface into the interior of the tank; and a control valve in fluid communication with the fluid flow interface. The control valve includes a source water inlet for receiving a flow of source water, a drain outlet, a treated water outlet and an air inlet, the control valve being operable to control a passage of fluids between the inlets and the outlets and the fluid flow interface, the control valve being operable to receive air from the air inlet and into the tank independently of a passage of treated water through the treated water outlet. A filtration media is contained within the tank, the filtration media including a media mixture of manganese dioxide coated silica core filtration media and iron hydroxide filtration media.

In accordance with another example embodiment, there is provided a method of regenerating filtration media within a water filtration system, the water filtration system including a tank defining an interior, a fluid flow interface into the interior of the tank, a control valve in fluid communication with the fluid flow interface, the control valve being programmable to perform a filtering service process, a backwashing process and an air downflow process through the water filtration system. The method includes: operating the control valve to perform the backwashing process; and operating the control valve to perform the air downflow process, wherein the filtration media includes a media mixture of manganese dioxide coated silica core filtration media and iron hydroxide filtration media.

### BRIEF DESCRIPTION OF THE FIGURES

Embodiments will now be described by way of example with reference to the accompanying drawings, in which like reference numerals are used to indicate similar features, and in which:

FIG. 1 shows a side diagrammatic view of a water filtration system in accordance with an example embodiment;

FIG. 2 shows a side sectional of a tank for the system shown in FIG. 1 in accordance with an example embodiment;

FIG. 3A shows a side view of a bottom distributor for the system shown in FIG. 1 in accordance with an example embodiment;

FIG. 3B shows an operational side view of the bottom distributor shown in FIG. 3A;

FIG. 3C shows an operational side view of the bottom distributor shown in FIG. 3A;

FIG. 4 shows an upper top distributor for the system shown in FIG. 1 in accordance with an example embodiment;

FIG. 5A shows a perspective view of a control valve in accordance with an example embodiment;

FIG. 5B shows a partial side view of the control valve shown in FIG. 5A;

FIG. 5C shows a side view of the control valve shown in FIG. 5A;

FIG. 5D shows an exploded view of a drive assembly for the control valve shown in FIG. 5A;

FIG. 6A shows a sectional view of the control valve shown in FIG. 5A in a filtering service mode in accordance with an example embodiment;

FIG. 6B shows a sectional view of the control valve shown in FIG. 5A in a backwash mode in accordance with an example embodiment;

FIG. 6C shows a sectional view of the control valve shown in FIG. 5A in a downflow air mode in accordance with an example embodiment;

FIG. 7 shows a perspective view of spring loaded check valve for the system shown in FIG. 1 in accordance with an example embodiment;

FIG. 8 shows an injector nozzle and venturi for the system shown in FIG. 1 in accordance with an example embodiment;

FIG. 9 illustrates a chart for the injector nozzle and venturi shown in FIG. 8;

FIG. 10 shows a perspective view of an air intake check valve for the system shown in FIG. 1 in accordance with an example embodiment;

FIG. 11A shows in diagrammatic form a drain line connection for the system shown in FIG. 1 in accordance with an example embodiment; and

FIG. 11B shows in diagrammatic form another drain line connection for the system shown in FIG. 1 in accordance with another example embodiment.

### DETAILED DESCRIPTION OF EXAMPLE EMBODIMENTS

In accordance with an example embodiment, there is provided a water filtration system, including a tank defining an interior; a fluid flow interface into the interior of the tank; and a control valve in fluid communication with the fluid flow interface. The control valve includes a source water inlet for receiving a flow of source water, a drain outlet, a treated water outlet and an air inlet, the control valve being operable to control a passage of fluids between the inlets and the outlets and the fluid flow interface, the control valve being operable to receive air from the air inlet and into the tank independently of a passage of treated water through the treated water outlet. A filtration media is contained within the tank, the filtration media including a media mixture of manganese dioxide coated silica core filtration media and iron hydroxide filtration media.

In accordance with another example embodiment, there is provided a method of regenerating filtration media within a water filtration system, the water filtration system including a tank defining an interior, a fluid flow interface into the interior of the tank, a control valve in fluid communication with the fluid flow interface, the control valve being programmable to perform a filtering service process, a backwashing process and an air downflow process through the water filtration system. The method includes: operating the control valve to perform the backwashing process; and operating the control valve to perform the air downflow process, wherein the filtration media includes a media mixture of manganese dioxide coated silica core filtration media and iron hydroxide filtration media.

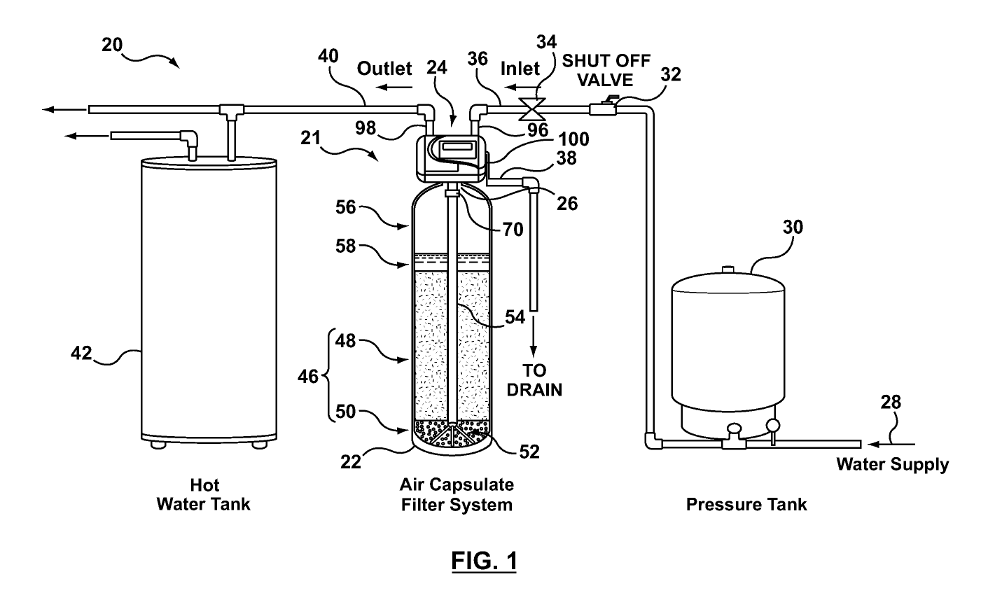

Reference is first made to FIG. 1, which shows a water filtration system 20 for filtering of raw water, in accordance with an example embodiment. The water filtration system 20 includes an air capsulate filter system 21 having a tank 22, a control valve 24, and a fluid flow interface 26 into the interior of the tank 22. Generally, the control valve 24 is operable to control a passage of fluids such as water or air between the fluid flow interface 26 and various inlets and the outlets of the control valve 24.

The water filtration system 20 further includes a water supply 28, a pressure tank 30, a shut off valve 32, a check valve 34, an inlet pipe 36, a drain line connection 38, an outlet pipe 40, and a hot water heater tank 42.

The tank 22 generally houses filtration media 46. In some example embodiments, the filtration media 46 includes a media mixture 48 supported by a support bed 50. The system 20 may also be configured to perform a regeneration process for cleansing or regeneration of the media mixture 48. The regeneration process may include a backwashing process and an air downflow process, described in greater detail herein.

A bottom distributor 52 within the tank 22 nests within the support bed 50. A central tube 54 extends from the bottom distributor 52 to a top of the tank 22 at the fluid flow interface 26.

Referring still to FIG. 1, in one example mode of operation, a filtering service process may perform the filtration of water. The tank 22 can receive fluids from the fluid flow interface 26. As shown, the tank 22 can further includes a head of air 56 for oxidation of water 58 as received from the fluid flow interface 26. The water 58 then proceeds through the filtration media 46 and up the central tube 54 to the control valve 24. The treated water then proceeds to the outlet pipe 40 to the hot water heater tank 42.

In some example embodiments, the media mixture 48 includes a mixture of manganese dioxide coated silica core filtration media and iron hydroxide (Fe(OH)3) filtration media. The media mixture 48 may be used for removing soluble iron, manganese, and hydrogen sulphide from the supplied water. The manganese dioxide coated surface promotes the oxidization reaction of iron, manganese, and hydrogen peroxide. The silica sand core allows it to withstand operating conditions in waters low in silica, TDS (total dissolved solids) and hardness.

The manganese dioxide coated silica core filtration media may be GreenSand Plus™. The iron hydroxide may be Filtersorb HSR™, which has an amorphous structure and wherein the ferric ions content is about 40% by weight. This media has a WQA Gold Seal Certification for compliance with NSF/ANSI Standard 61, as would be understood in the art. In an example embodiment, the specification of the media mixture 48 may be as follows, as would be understood in the art:

Physical Form: Black nodular granules, shipped dry;
Apparent Density: 85 pounds per cubic foot (+/−5%);
Bulk Density: 87-89 pounds per cubic foot;

### Specific Gravity: Approximately 2.4;

U.S. Sieve Size: 18×60 mesh;

### Effective Size: 0.30-0.35 mm;

Backwash Rate (Minimum): 12 gpm/sq ft @ 55 degrees Fahrenheit;
Pressure Drop @ 2 gpm/sq ft @60° F.: <0.27 psig per foot of bed depth;
Manganese Removal Capacity, grains: 300 minimum; and
pH: 6.2 to 8.5.

In an example embodiment, the support bed 50 includes a gravel filtration media such as Red Flint Gravel, for example #20 Flint Gravel. The Red Flint Gravel is composed of sub-angular, hard, durable, and dense grains of predominately siliceous material. Extracted from a clean glacial deposit, Red Flint Gravel's physical properties make it among the finest available in the world for water filtration applications. Red Flint Gravel is washed, kiln dried, and screened to meet exacting specifications with strict adherence to quality control. Red Flint Gravel is manufactured by American Materials Corp. and is classified by Underwriters Laboratories Inc™ in accordance with standard ANSI/NSF 61, as would be understood in the art.

In an example embodiment, the specification of the #20 Flint Gravel may be as follows, as would be understood in the art:

Color: yellow/brown;
Shape: sub-angular, fractured;
Hardness: 7-8 on MOH scale; and
Bulk Density: 100 lbs per cubic foot.

In an example embodiment, the GreensandPlus™ filtration media, the FilterSorb HSR™ filtration media, and the #20 Flint Gravel filtration media are contained within the tank 22 in a ratio of 80:15:5 by mass. This amounts to an 80%, 15%, and 5% breakdown by mass, respectively.

As shown in FIG. 1, the control valve 24 includes a source water inlet 96 for receiving a flow of source water and a treated water outlet 98. The control valve 24 is installed on the raw water inlet of water to be treated. The one way spring loaded check valve 34 is installed allowing the water flow through a pipe 36 to the inlet 98 of the control valve 24. As shown, after the check valve 34, the water pipe 36 is connected to the inlet 98 of the control valve 24. The treated water outlet 98 of the control valve 24 outputs treated water to service demand. The control valve 24 also includes a drain outlet 100 for connection to the drain line connection 38.

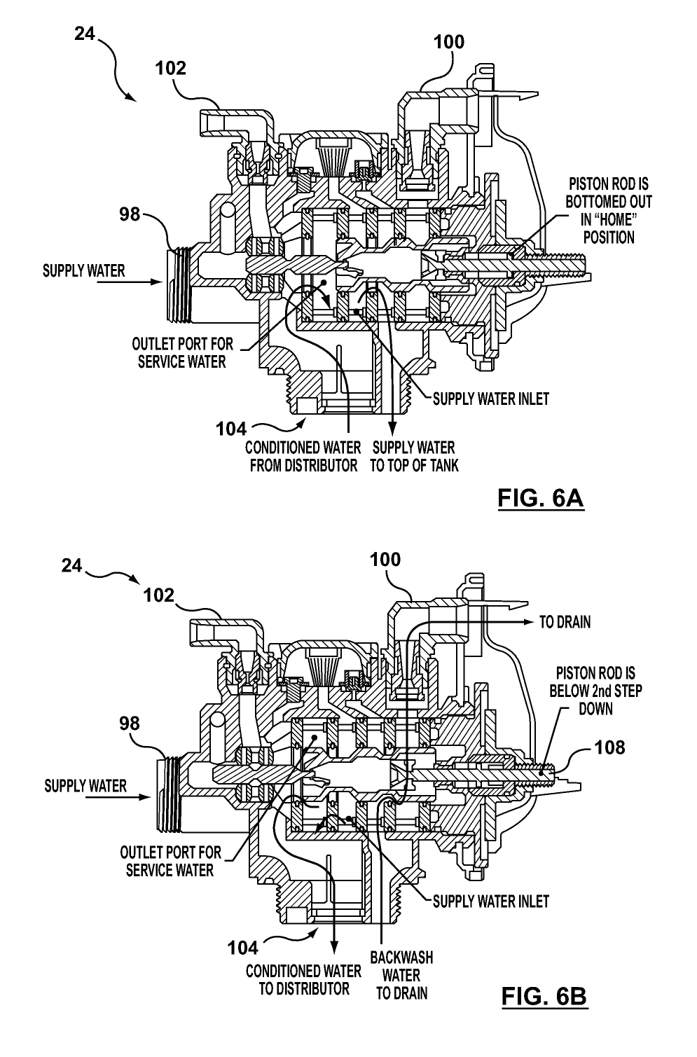

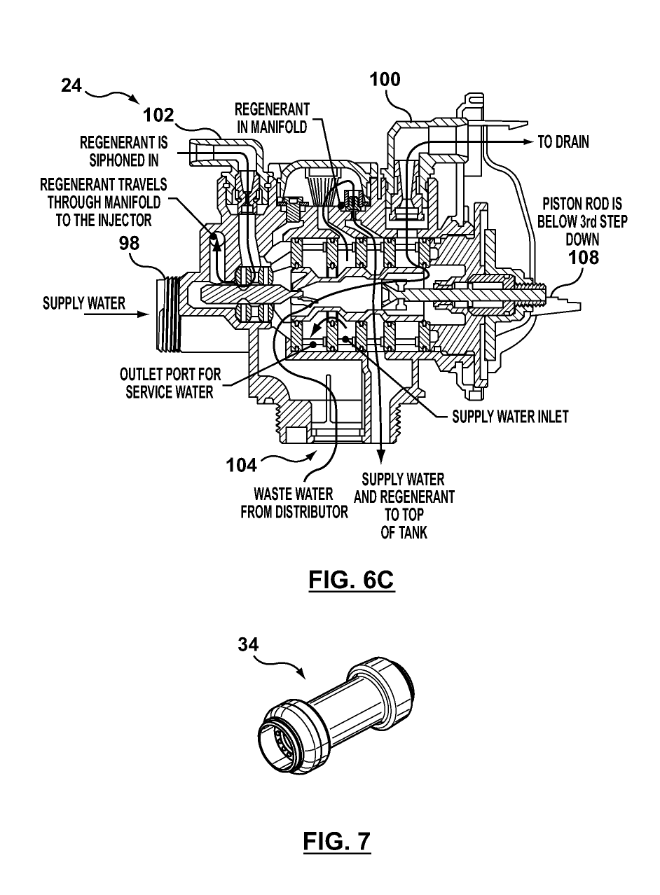

Reference is now made to FIGS. 6A to 6C, which show the control valve 24 in various modes of operation, in accordance with example embodiments. FIG. 6A shows the control valve 24 in a filtering service mode, FIG. 6B shows the control valve 24 in a backwash mode, and FIG. 6C shows the control valve 24 in a downflow air mode. The control valve 24 has an interface 104 which is in fluid communication with the fluid flow interface 26 of the tank 22. Generally, the control valve 24 is operable to control a passage of fluids between the various inlets and the outlets and the interface 104. The interface 104 can include two separate ports to the tank 22, as shown. The control valve 24 material may be formed from Noryl™, as would be understood in the art. An example of a suitable control valve 24 is a control valve manufactured by Clack Corp., for example a WS1 control valve.

As shown in FIG. 6C, an air inlet 102 may be used to receive a regenerent (e.g., air in example embodiments). The control valve 24 is operable to receive air from the air inlet 102 and into the tank 22 independently of a passage of treated water through the treated water outlet 98.

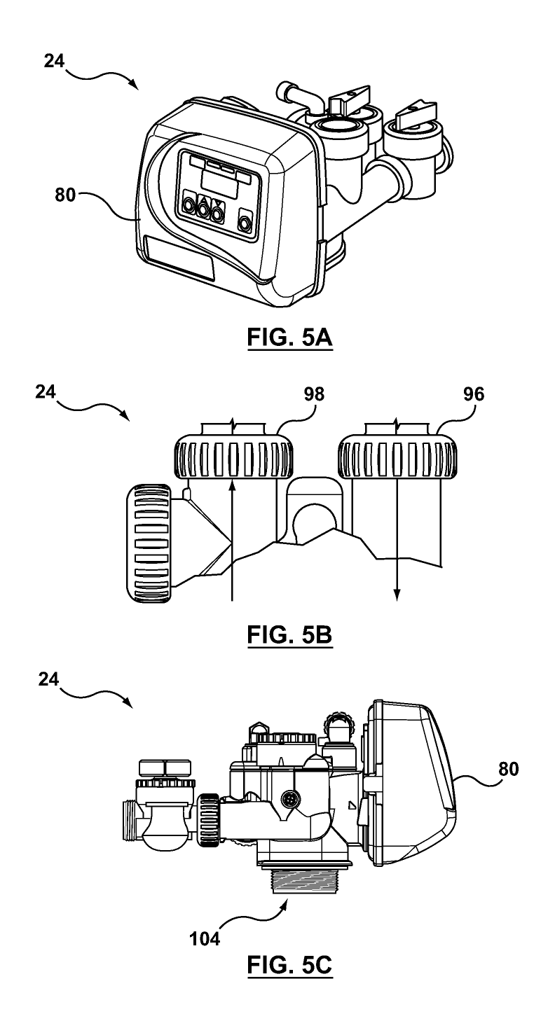

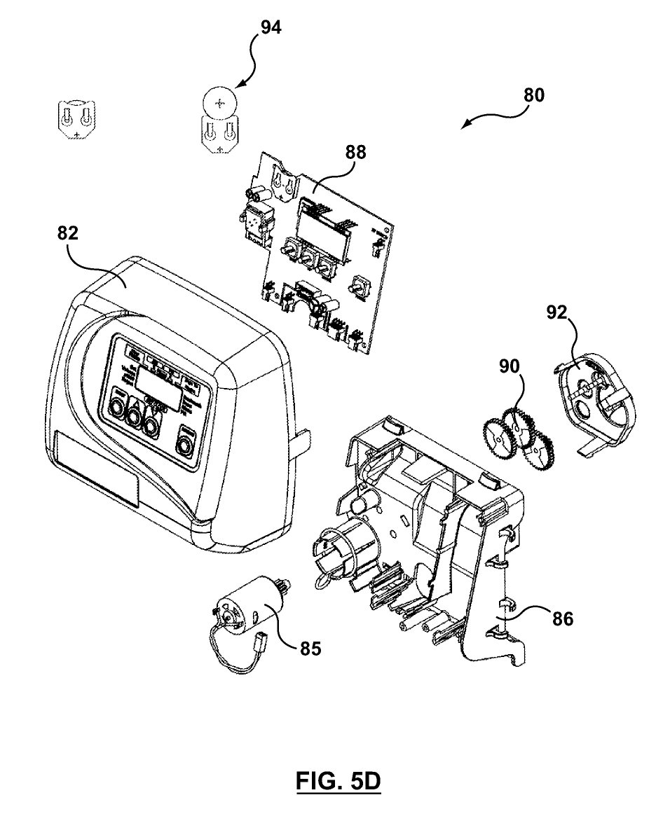

Reference is now made to FIG. 5D, which shows in detail a drive assembly 80 for the control valve 24. Generally, the drive assembly 80 may be programmed for adjusting of a sequence and timing of a plurality of water treatment processes. For example, the programmed sequence can include a filtering service process, a backwashing process and/or an air downflow process. Referring to FIG. 6A, the drive assembly 80 is used to control and move a piston rod 108 to various positions, each position representing one of the modes or processes described herein.

As shown in FIG. 5D, the drive assembly 80 includes a front cover assembly 82, a motor 84, a drive bracket (and spring clip) 86, a circuit board controller 88, drive gear 90, and gear cover 92. The drive assembly 80 may for example be powered by a battery 94.

The control valve 24 may be utilized as a downflow regeneration type function process with 6 cycles fully adjustable cycles capable of being configured with the following functions:

### Control Valve Cycles of Operation: Range of Time in Minutes:

1. Backwash 1st (upflow): 1-20 or OFF;

### 2. Regenerate Draw/Slow Rinse: 1-99 or OFF;

3. Backwash 2nd (upflow): 1-20 or OFF;
4. Fast Rinse (downflow): 1-20 or OFF;

### 5. Regenerant Refill: 0.1-99.0 or OFF; and

6. Service (downflow).

The control valve 24 has the ability to turn cycle sequences “OFF” for the processes of the system 20. By utilizing the backwash 1st cycle, and then the regenerant air draw only and turning off all other control valve cycle sequences, the system 20 may achieve the backwash and air draw fast rinse through the control valve 24. The control valve 24 may have an operating temperature of 40°-110° F. and an operating pressure of 20 psi-125 psi.

Electrical required supplied voltage is 120 VAC with a frequency of 60 Hz operating at an output voltage of 12 VAC with an output current of 500 mA low voltage for easy and safe operation through a North American style plug in type step down transformer. The control valve 24 can perform the function of the valve piston assembly in the service filtering position allowing the passage of untreated water through the air capsulate control valve to be filtered; backwash expansion to remove any suspended solids and oxidized matter trapped in the filtration media 46; and air injection through a nozzle and venturi process into the control valve 24 through into the tank 22 capsulated for oxidation of raw water impurities. Top distributor pilot opening is 1.05″ OD pipe or (¾″ NPS) with a drain line discharge connection of ¾″ or 1″ male thread, with a standard tank size thread of 2½″-8 NPSM. Nozzle & venturi elbow with injector to allow the control valve 24 to draw in atmospheric air through the control valve 24 in sequence transferring the air into the mineral tank 22 for the oxidation process.

In example embodiments, the control valve 24 may be configured with the following process:

### Control Valve Cycles of Operation: Range of Time in Minutes:

1. Backwash 1st (upflow): 10;

### 2. Regenerate Draw/Slow Rinse: 60;

3. Backwash 2nd (upflow): OFF;
4. Fast Rinse (downflow): OFF;

### 5. Regenerant Refill: OFF; and

6. Service (downflow).

This may be programmed to be performed at suitable intervals, for example once per day.

Referring again to FIGS. 6A to 6C, the filtering service process, the backwashing process and the air downflow process will now be described in greater detail. As shown in the filtering service process of FIG. 6A, with reference to FIG. 1, untreated pressurized water will flow through the one way spring loaded check valve 34 that will only allow water to pass one way to the control valve 24 and not allow any water back pressure or capsulated air back out of the system 20. Raw unfiltered water will travel into the inlet 96 of the control valve 24 with the piston rod 108 bottomed in the service filtering position (representing the filtering service mode). This feed water will travel through a spacer stack assembly through the control valve 24 through the fluid flow interface 26 of the tank 22, into a capsulate of air 56 which will perform the oxidation of any minerals iron, and chemical elements such as Hydrogen Sulphide and manganese in the feed water. The feed supply after oxidized will travel through water before coming into contact with the filtration media mixture 48 where the absorption process will remove any oxidized minerals, suspended solids, and or chemical elements from the raw water supply. After passing through the filtration media mixture 48, the treated water will then pass through a washed gravel quartz gravel support bed 50 designed to prevent pressure drop achieving higher flow rates through larger channels of transportation for the water. This support bed 50 will also keep the filtration media mixture 48 from plugging onto the bottom distributor 52 eliminating any type of pressure drop in the system 20.

Water then will be collected through the bottom distributor 52 for maximum flow rates and minimum pressure drop in the service filtering operation position. With the bottom distributor 52 the system 20 collects the treated filtered water evenly across the entire filtration support bed 50 allowing for all water passing through the filtration media mixture 48 to achieve the maximum contact time for proper filtration, minimum pressure drop and higher service flow rates. The filtered water will then flow through a 1.05″ distributor tube 54 back up into the control valve 24 where it will pass through another section porting in the control valve 24 through the spacer stack assembly to the outlet port 98 of the control valve 24 providing service treated filtered water to demand.

As shown in the backwash process of FIG. 6B, with reference to FIG. 1, the system 20 can be configured to perform the function of backwash which is the first stage in the regeneration process of cleaning the media filtration support bed 50. The motor driven control valve 24 will automatically drive the piston rod 108 to where the piston rod 108 is below the 2nd step down allowing the raw water feed inlet 98 into the control valve 24 through the spacer stack assembly supplied down through the 1.05″ distributor tube 54 across each of the bottom distributor 52. With this process the system 20 can save up to 35% of waste (backwash) water per regeneration cycle which can result in zero channeling or solidifying of the media support bed 50 which can increase the life expectancy of the filtration media by 50%. This allows the water flow to lift the filtration mixed media 48 upward inside of the mineral tank 22 releasing first the capsulate of air 56 out through the drain line connection 38. Once all of the air 56 is eliminated the water 58 will now pass upward through the mixed media 48 and out the backwash drain line connection 38, thereby performing the function of downflow backwash. The system 20 has a specific amount of freeboard from the top of the mixed media 48 while in backwash with a supplied amount of water produced through a drain line flow control to not allow the mixed media 48 to reach the top of the mineral tank 22 when in this cycle of operation. Proper backwash bed expansion of 30% is maintained at a specific flow rate to backwash, and cleans the filtration media 46 properly. The backwash flow rate through the mixed media 48 utilizes 10-12 gpm/sq.ft. of bed area determined by the diameter of the vessel mineral tank 22. Filtered and collected particles, suspended matter, minerals, and chemical elements are released out of the filtration support bed 50. The backwash water upward through the filtration media 46 will pass through the upper top distributor 70 through the control valve spacer stack to the outlet drain port 100 within the control valve 24. The backwash water flows outward through the drain elbow or straight drain line flow control to the drain connection 38. In some example embodiments, brine may be used for the backwash water.

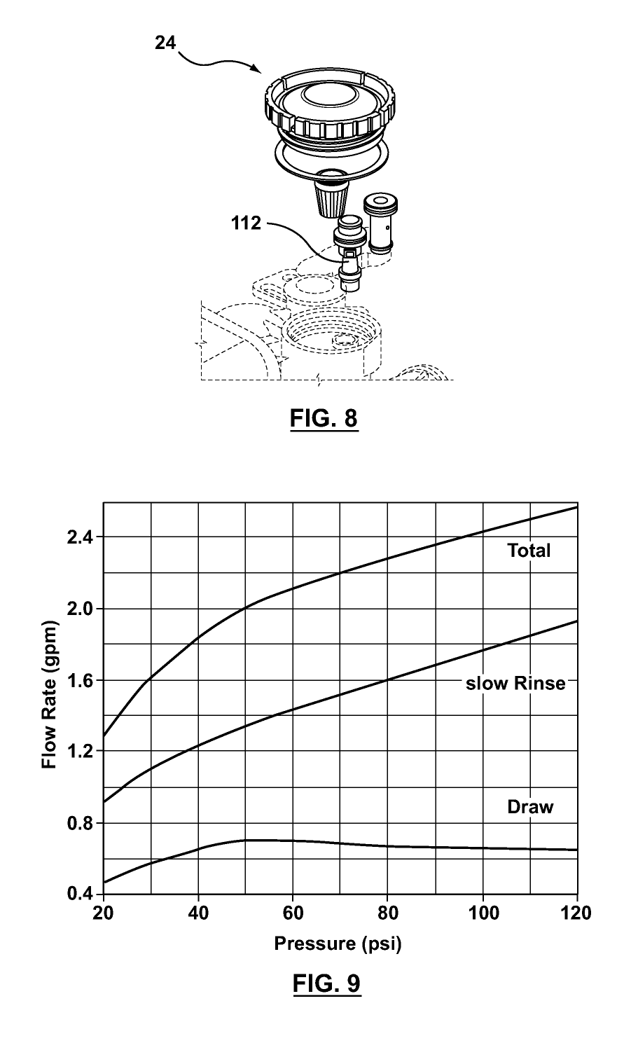

Referring now to the air downflow process of FIG. 6C, with reference to FIG. 1, The motor driven control valve 24 will now drive the piston rod 108 through the spacer stack wherein the piston rod 108 is below the 3rd step down within the control valve 24. While in this position the regenerate (air) travels through a manifold through the injector 112 (FIG. 8) through the control valve 24 forced into the mineral tank 22. During this process the control valve 24 allows a stream of water out to the drain connection 38 which allows for the portion of air required be regeneration to enter into the mineral tank 22 oxidizing all of the water out of the vessel mineral tank 22 down through the filtration media 46. Maximum oxygen contact time allows for higher filtration media characteristics based on a time of 40 minutes in this cycle.

After this cycle the motor driven control valve 24 will drive the piston rod 108 and assembly back through the shut off cycles through the fully adjustable 6 cycle control valve allowing water to enter back through the control valve 24 into the mineral tank 22 releasing a specific amount of air out the drain line connection 38. Once the piston rod 108 is bottomed back into the home filtering position there is a capsulate of air 56 trapped in the top portion of the pressurized filtration vessel mineral tank 22 which will allow for another session of treated water in the service position mode.

In some example embodiments, the ability of the control valve 24 to fully adjust and turn ON or OFF cycle times is combined with specific filtration media 46, distributor designs, and installation properties which are designed and based on the operation of the air capsulate system. Other components, media, and valves within this design can adjust the size and flow rate of the air capsulate filter system achieving similar results.

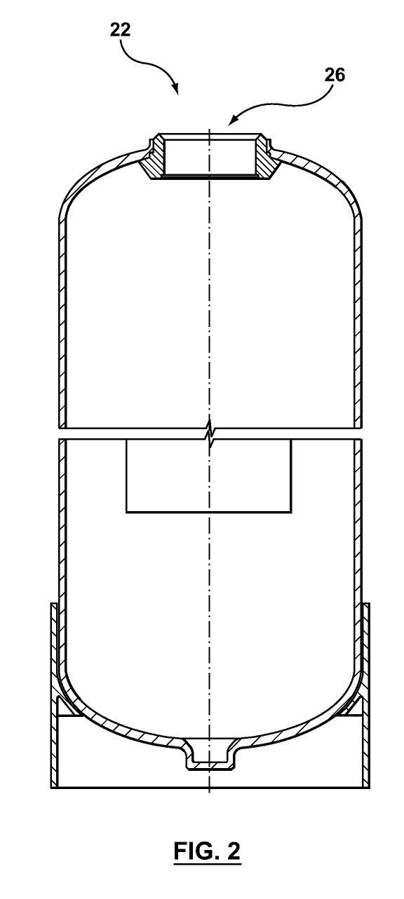

Reference is now made to FIG. 2, which shows the tank 22 in greater detail. The tank 22 may be a mineral tank having polyethylene (PE) liner with fibre-reinforced plastic (FRP) filament winding maximum operating pressure up to 150 psig with a maximum operating temperature of 120° F. The mineral tank may be NSF/ANSI Standard 44 and PED (Pressure Equipment Directive) certified. The fluid flow interface 26 may define an opening at the top of the tank 22 which can be 2.5″ thread, 4.0″ thread, or 6″ flanged for connection of the control valve filter control valve 24 (FIG. 1).

An example of a suitable mineral tank 22 is manufactured by Wave Cyber (Shanghai) Co., Ltd., wholly owned by Wave Cyber Limited, a BVI company. It can be appreciated that other mechanical housings with an interior pressure design for fluids with top openings may be utilized as the tank 22.

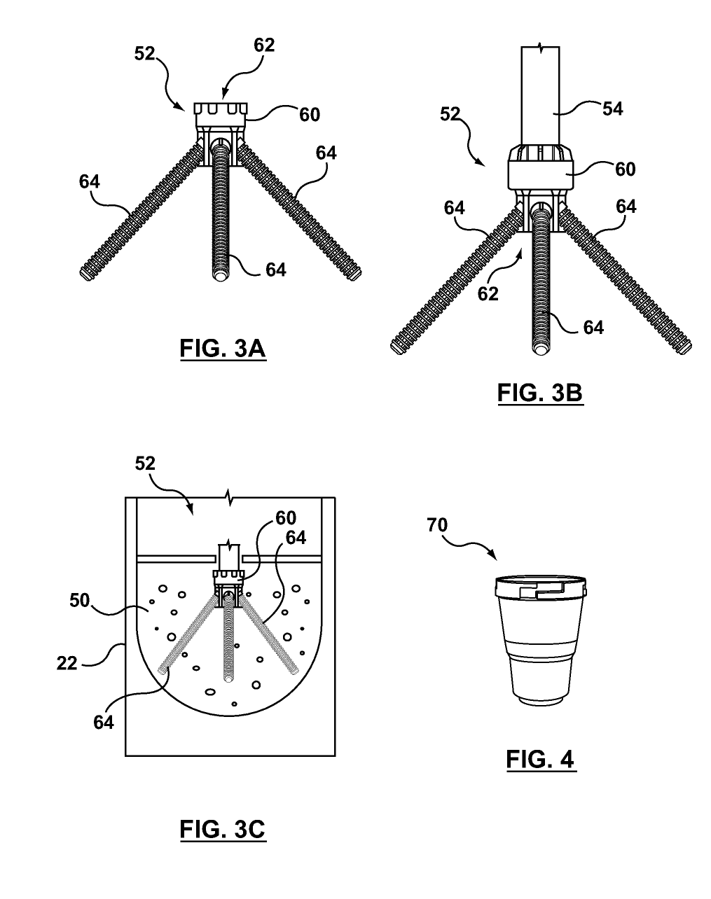

Reference is now made to FIGS. 3A to 3C, which shows the bottom distributor 52 in greater detail. The bottom distributor 52 includes a central hub 60 defining a passage 62 and a plurality of flexible lateral members 64 extending outwardly from the central hub 60 for engaging the support bed 50. The passage 62 can engage the central tube 54, for passage of treated water upwardly to the control valve 24 (FIG. 1).

In an example embodiment, the bottom distributor 52 is a Vortex™ spider flexible hub and lateral 1.05° distributor which is used for filtered water collection through the bottom flexible adjusting lateral members 64 for maximum flow rates and minimum pressure drop in the service filtering operation process. With this bottom distributor 52, there may be saved up to 35% of waste (backwash) water per regeneration cycle, resulting in zero channeling or solidifying of the media bed which may increase the life expectancy of the filtration media by 50%. The bottom distributor 52 may be easily inserted to fit any standard pressure vessel ranging in sizes from 7 inches to 24 inches in diameter with 2.5 inch, 4.0 inch, or 6 inch flanged top tank openings. The Vortex™ spider flexible hub is manufactured by Vortex Envirotech.

Reference is now made to FIG. 4, which shows an upper top distributor 70 to be used in the system 20 of FIG. 1. In an example embodiment, the upper top distributor 70 is a bayonet style upper top distributor made out of high impact FDA (Food and Drug Administration) approved ABS (Acrylonitrile Butadiene Styrene) plastic which define slots having a fixed slot size of 0.010″-0.013″ allowing for the passage of water out of the control valve 24 into the tank 22 upper distributor screen prior to contact with air 56 and the media mixture 48. This also prevents any media mixture 48 from entering into the control valve 24 in the backwash process of the regeneration process. The upper top distributor may be a twist-on style, model D1203, as understood in the art.

Reference is now made to FIG. 7, which shows the one way check valve 34 in greater detail. The spring loaded check valve 34 on the inlet feed water supply 28 to the control valve 24 is used in the system 20 to prevent any air from the enclosed pressurized control valve 24 from escaping.

Reference is now made to FIG. 8, which shows an injector nozzle and venturi 110 in greater detail. When in the air downflow process, the injector nozzle and venture 110 allows water to pass through the control valve 24 through the nozzle allowing for the injector 112 to draw in atmospheric air into the vessel tank 22 through the control valve 24 for the oxidation process of the system 20. As illustrated in FIG. 9, the injector 112 may have the shown flow rate properties with respect to pressure in the various modes of operation.

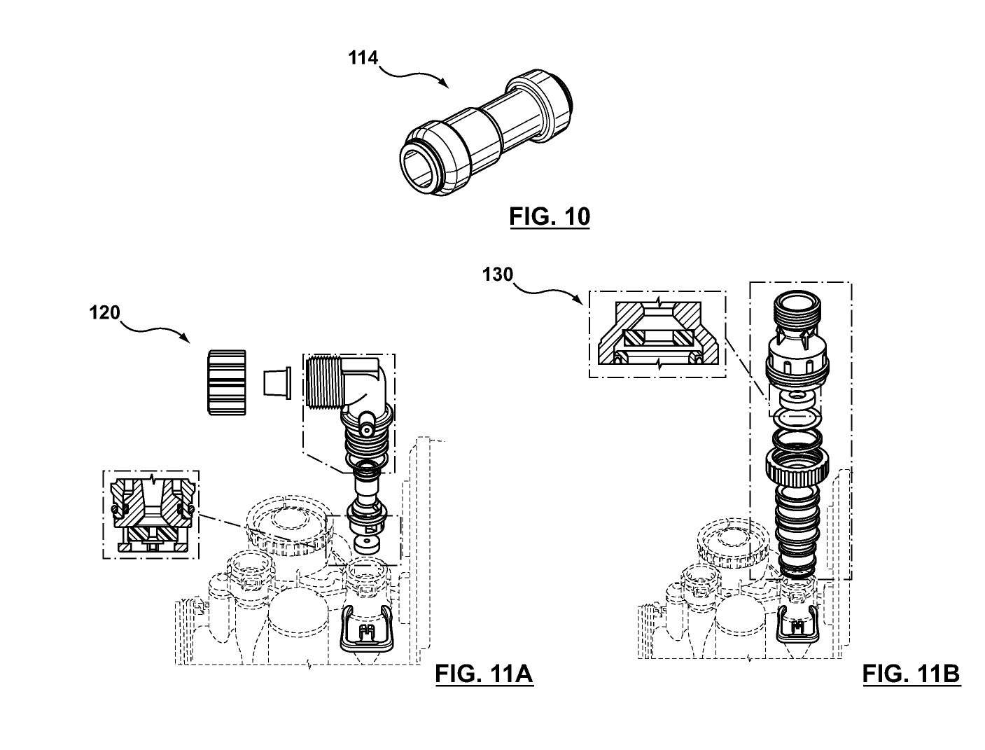

Reference is now made to FIG. 10, which shows an air intake check valve 114 in greater detail. The air intake check valve 114 may be a one way ⅜″ check valve on polyethylene tubing connected to the air inlet 102 on the control valve 24 which has two functions. One is to allow the injection of atmospheric air into the control valve 24 through the venture 110, and the second is to prevent water from discharging out through the venturi 110 when the motor driven control valve 24 positions the piston assembly through the shut off stages after regeneration back to the service filtering process. In an example embodiment, the specification of the air intake check valve 114 may be as follows, as would be understood in the art:

### Materials: (Body: Acetal; O-ring: EPDM; Metal Grip Edge: 300 Stainless);

### Working Pressure: +34° F. (1° C.) to 150° F. (65° C.);

Temperature Range: up to 150 PSI depending on tubing being used; and
Cracking Pressure: ⅓ PSI.

Referring now to FIGS. 11A and 11B, the outlet 100 of the control valve 24 is piped and connected to the drain line connection 38, for example, a drain line connection 120 (FIG. 11A) which is ¾″ threaded or a drain line connection 130 (FIG. 11B) which is 1″ threaded. For example, the control valve 24 will perform the function of backwash which will have either a ¾″ or 1″ male thread drain line connection 38 on the top of the control valve 24 which will be piped to the outlet 100 to drain the air 56 within the tank 22. The drain line connection 38 will vary depending on the size of the mineral tank 22 utilized in the system 20 which may require different backwash flow rates.

Certain adaptations and modifications of the described embodiments can be made. Therefore, the above discussed embodiments are considered to be illustrative and not restrictive. Example embodiments described as methods would similarly apply to systems, and vice-versa.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

What is claimed is:

1. A water filtration system, comprising:
a tank defining an interior;
a fluid flow interface into the interior of the tank;
a control valve in fluid communication with the fluid flow interface, the control valve including a source water inlet for receiving a flow of source water, a drain outlet, a treated water outlet and an air inlet, the control valve being operable to control a passage of fluids between the inlets and the outlets and the fluid flow interface, the control valve being operable to receive air from the air inlet and into the tank independently of a passage of treated water through the treated water outlet; and
a filtration media contained within the tank, the filtration media including a media mixture of manganese dioxide coated silica core filtration media and iron hydroxide filtration media.

2. The water filtration system as claimed in claim 1, wherein the manganese dioxide coated silica core filtration media is GreensandPlus™.

3. The water filtration system as claimed in claim 2, wherein the iron hydroxide filtration media is FilterSorb HSR™.

4. The water filtration system as claimed in claim 3, wherein the GreensandPlus™ filtration media and the FilterSorb HSR™ filtration media are mixed in a ratio of 80:15 by mass.

5. The water filtration system as claimed in claim 1, wherein the filtration media further includes a support bed for supporting of the media mixture.

6. The water filtration system as claimed in claim 1, wherein the support bed comprises Red Flint Gravel filtration media.

7. The water filtration system as claimed in claim 6, wherein the Red Flint Gravel filtration media further comprises includes #20 Flint Gravel filtration media.

8. The water filtration system as claimed in claim 6, further comprising a bottom distributor within the tank including a central hub defining a passage and a plurality of flexible lateral members extending outwardly from the central hub for engaging the support bed.

9. The water filtration system as claimed in claim 1, wherein the filtration media further comprises #20 Flint Gravel filtration media, wherein the manganese dioxide coated silica core filtration media includes GreensandPlus™, wherein the iron hydroxide filtration media includes FilterSorb HSR™, and wherein the GreensandPlus™ filtration media, the FilterSorb HSR™ filtration media, and the #20 Flint Gravel filtration media are contained within the tank in a ratio of 80:15:5 by mass.

10. The water filtration system as claimed in claim 1, wherein the control valve includes a programmable device for adjusting of a sequence and timing of a plurality of water treatment processes.

11. The water filtration system as claimed in claim 10, wherein the plurality of water treatment processes including a filtering service process, a backwashing process and an air downflow process.

12. The water filtration system as claimed in claim 11, wherein the programmable device is programmed to perform the backwashing process for 10 minutes and the air downflow process for 60 minutes.

13. A method of regenerating filtration media within a water filtration system, the water filtration system including a tank defining an interior, a fluid flow interface into the interior of the tank, a control valve in fluid communication with the fluid flow interface, the control valve being programmable to perform a filtering service process, a backwashing process and an air downflow process through the water filtration system, the method comprising:
operating the control valve to perform the backwashing process; and
operating the control valve to perform the air downflow process, wherein the filtration media includes a media mixture of manganese dioxide coated silica core filtration media and iron hydroxide filtration media.

14. The method as claimed in claim 13, wherein the backwashing process is performed for 10 minutes.

15. The method as claimed in claim 13, wherein the air downflow process is performed for 60 minutes.

16. The method as claimed in claim 13, wherein the manganese dioxide coated silica core filtration media is GreensandPlus™.

17. The method as claimed in claim 16, wherein the iron hydroxide filtration media is FilterSorb HSR™.

18. The method as claimed in claim 17, wherein the GreensandPlus™ filtration media and the FilterSorb HSR™ filtration media are mixed in a ratio of 80:15 by mass.

19. The method as claimed in claim 13, wherein the filtration system includes a bottom distributor within the tank including a central hub defining a passage and a plurality of flexible lateral members extending outwardly from the central hub for engaging the filtration media.
